(19) United States
(12) Patent Application Publication
(10) Pub. No.: US 2009/0072656 A1
(43) Pub. Date: Mar. 19, 2009

(54) Four-pole electric motor drive with hammer brush holder system

(75) Inventors: Horst Eisert, Waldbuttelbrunn (DE); Sandra Michel, Wittighausen (DE); Manfred Striedacher, Kitzingen (DE)

Correspondence Address: MANELLI DENISON & SELTER, 2000 M STREET NW SUITE 700, WASHINGTON, DC, 20036-3307, US

(73) Assignee: Brose Fahrzeugteile GmbH & Co. Kommanditgesellschaft, Wurzburg, Wurzburg (DE)

(21) Appl. No.: 12/232,225

(22) Filed: Sep. 12, 2008

(30) Foreign Application Priority Data
Sep. 18, 2007 (DE) 10 2007 004 399.6

(51) Int. Cl. H01R 39/39

(52) U.S. Cl. 310/244

(57) ABSTRACT

The invention relates to a four-pole electric motor drive which has a stator and a rotor. The rotor contains a rotor shaft, a laminated rotor core containing rotor teeth, and a commutator fitted with segments. Furthermore, the drive has a hammer brush holder system which has a frame, brush support arms, one end of each arm having a brush receiver, and the other end of each arm being connected to the frame via a rotatable bearing arrangement, and carbon brushes, each of which is inserted in one of the brush receivers.

The invention relates to a four-pole electric motor drive with a hammer brush holder system.

Electric motor drives which have a stator and a rotor are already known, it being possible for the rotor to contain a rotor shaft, a laminated rotor core and a commutator fitted with segments. Such types of electric motor drives are used for example in motor vehicles as drive motors in connection with a power steering system, an automatic braking system and a cooling fan.

Furthermore, brush systems are already known in which the carbon brushes are guided in cartridge-type brush holders. A disadvantage of these brush systems is that in operation they are susceptible to sand and other dirt. The result of this can be that the carbon brushes are no longer able to move in the desired manner in the respective holder but become jammed. This results in failure of the brush system and consequently of the entire electric motor drive.

Moreover, brush systems are already known in which so-called hammer holders are employed as brush holders. The disadvantage of these systems is the high space requirement, which is a hindrance in small motors.

A plastic hammer brush holder arrangement is known from EP 0 651 472 B1, which has a brush support arm, one end of which is fitted with a brush receiver and the other end is fitted with a rotatable bearing arrangement. Furthermore, the free outer faces of the brush support arm are fitted with a noise-deadening and/or noise-damping sheath.

A plastic hammer-type brush holder in the form of a pivoted arm for an electric machine is known from EP 0 791 988 B1. Here a box-shaped brush receptacle is provided at one end of the pivoted arm and at least one pivoted bearing arrangement at the other end. Furthermore, the pivoted arm contains a thin-walled web connecting the pivoted bearing arrangement to the box-shaped brush receptacle. Said thin-walled web spreads open, at least at one of its ends, into the lateral longitudinal walls of the box-shaped brush receptacle, which essentially run parallel to the connecting web.

The object of the invention consists in specifying a four-pole electric motor drive whose brush system can be constructed with simple and economical means and is nevertheless insensitive to sand and other dirt.

This object is achieved by a four-pole electric motor drive having the features stated in claim 1. Advantageous embodiments and developments of the invention are revealed in the dependent claims.

The advantages of the invention are, in particular, that the operation of the electric motor drive, both in service and also in the event of ingress of sand or other dirt, is longer than with known electric motor drives. This can be attributed to the fact that the carbon brushes are not guided inside a cartridge-type brush holder but in each case in a box-shaped brush receiver of a brush support arm, whose outer end has a rotatable bearing arrangement. In such a bearing arrangement the sliding surfaces are reduced to a minimum. Due to a clever arrangement of these sliding surfaces and of the spring elements of the brush system, which advantageously are leg springs, it can be ensured to a large extent that these surfaces are protected against contaminants. In addition, a brush system according to the invention has a reduced number of components and can be realized in a space-saving and economical manner.

It is particularly advantageous that the brush system realized as a hammer brush holder is equipped with only two brush support arms in whose brush receiver one carbon brush is used in each case, and that each of the commutator segments which are offset from each other by 1800 are interconnected via an electrical conductor. The existence of a total of four carbon brushes is simulated by these connections, although only two carbon brushes are present. Compared to the prior art, this represents a considerable saving in the number of components employed, and therefore also a considerable space saving. The architecture described above particularly favors the use of hammer brush holder systems which potentially require inherently a lot of space, even in conjunction with four-pole applications.

In this case the two brush support arms are offset by 90° from each other on the frame of the brush system.

This has the advantage that a comparatively large amount of space remains on the frame for mounting the interference suppression components required for a brush system and—if desired—a thermal protection device. In addition, there is still plenty of space which can be used for cooling air openings.

The necessary electrical connections between the carbon brushes and the interference suppression components are advantageously realized by means of one of more solid wire links. This saves further space. Furthermore, solid wire is a low-cost component which is readily available in the trade and which can be easily installed in the brush system. Moreover, use of solid wire has the advantage that additional components can be easily incorporated in the system at a later date since the necessary electrical contact between the solid wire and the additional component can be made without prior removal of insulation, etc.

Further advantageous features of the invention are revealed in their exemplary explanation with the aid of the figures, in which:

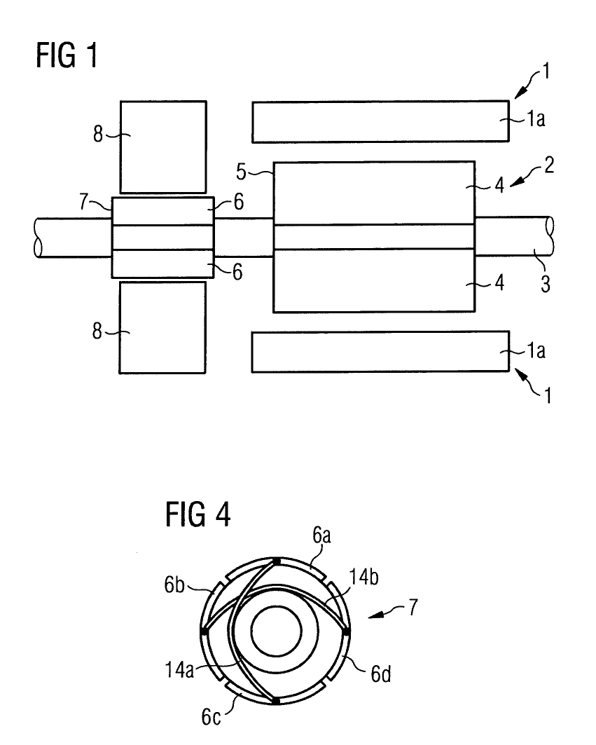

FIG. 1 shows a sketch for illustrating the main components of an electric motor drive according to the invention,

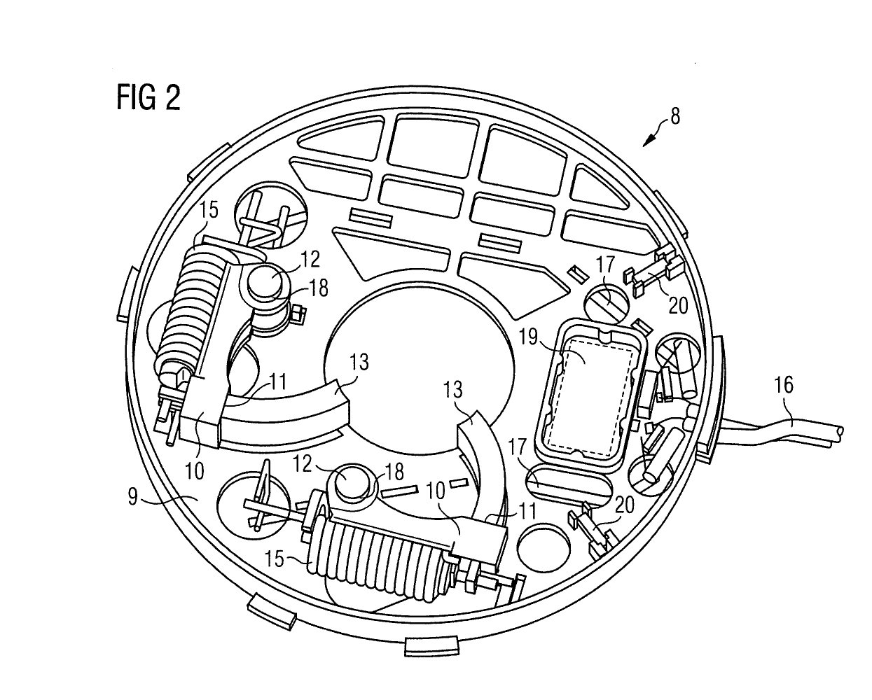

FIG. 2 shows a perspective representation of the top side of a hammer brush holder system,

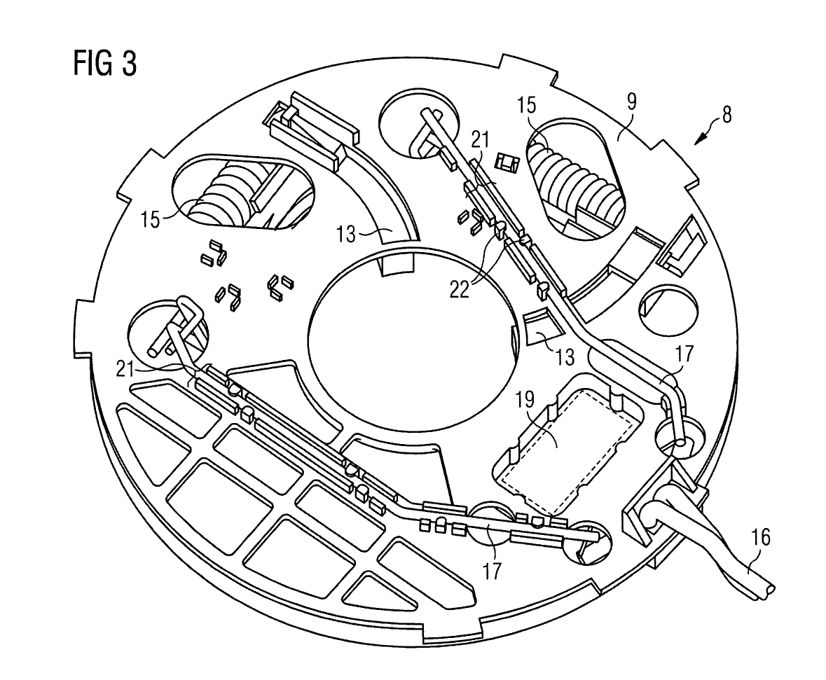

FIG. 3 shows a perspective representation of the underside of the hammer brush system of FIG. 2 and

FIG. 4 shows a schematic view of the end face of the commutator of an electric motor drive according to the invention.

FIG. 1 shows a sketch for illustrating the main components of an electric motor drive according to the invention. This drive is a four-pole drive which is used in conjunction with the cooling fan of a motor vehicle.

The electric motor drive as shown has a stator 1, with a total of four associated stator poles la. Furthermore, said drive has a rotor 2, with associated rotor shaft 3, a laminated rotor core 5 containing rotor teeth 4, and a commutator 7 fitted with segments 6. The segments 6 are distributed equidistantly around the periphery of the commutator. Each of the segments is arranged at a specified distance from the respective adjacent segment around the periphery of the commutator.

In addition, the illustrated electric motor drive has a brush system 8, which is realized in the form of a hammer brush holder system whose carbon brushes make contact with the segments 6 of the commutator 7 during operation.

FIG. 2 shows a perspective representation of the top side of a hammer brush holder system 8. This has a frame 9 consisting of plastic, which has a profile construction and to which the additional components of the brush system are attached.

These additional components include two brush support arms 10 embodied in the form of a hammer holder. Each of these brush support arms 10 has a first end at which a brush receiver 11 is located. A carbon brush 13 is inserted in this brush receiver 11. During the operation of the electric motor drive no relative movement occurs between the respective carbon brush 13 and the associated brush support arm 10. Furthermore, each of these brush support arms has a second end at which it is connected to the frame 9 by means of a rotatable bearing arrangement 12. A leg spring 18, which extends in the axial direction, is inserted in each case in the region of the rotatable bearing arrangement 12. If the carbon brush 13 moves outwards in the radial direction, that is to say is lifted off from the commutator, then the leg spring 18 is pretensioned. If the carbon brush 13 moves inwards in the radial direction, that is to say in the direction of the commutator, then the leg spring 18 is unloaded.

In a brush system constructed in such a way the sliding surfaces are minimized during operation. They occur only in the region of the rotatable bearing arrangements 12 of the brush support arms 10 and can be arranged in such a way that they are largely protected from contaminants. Advantageously, the carbon brushes 13 themselves are firmly inserted in the brush receivers 11 of the brush support arms 10 and in operation make no relative movements in relation to the respective brush support arm.

In addition, the hammer brush holder system shown in FIG. 2 has interference suppression components 15, which are interference suppression coils. In each case these extend parallel to one of the brush support arms, so that they are supported in the brush system in a space-saving manner. Furthermore, the illustrated brush system has interference suppression capacitors 20.

The necessary electrical connections between the carbon brushes 13, the interference suppression components 15, 20 and an electrical connecting cable 16 are made using one or more solid wire links 17. Solid wire is a low-cost component which is readily available in the trade and can be easily cut each time to the necessary length, then bent into the desired shape and finally attached to the frame 9, which is preferably fitted with wire guideways, inside which clamping means for retaining the solid wire are provided.

Furthermore, a recess is provided in the profiled frame 9, in which—if this is required—a thermal protection element 19 can be inserted, as denoted by the broken line in FIG. 2.

FIG. 3 shows a perspective representation of the underside of the hammer brush system 8 of FIG. 2. It is particularly clear from FIG. 3 that the electrical connections used here are solid wire links 17, which have been made into the desired shape by bending and then inserted in wire guideways 21 provided on the frame 9. Each of these wire guideways has two boundary walls standing at right-angles to the frame 9, between which walls the respective solid wire link 17 is inserted. For its retention in the respective wire guideway, clamping means 22, comprising inwards-facing projections, are provided. The frame 9 and the guideways 21 are realized in the form of a one-piece injection molded plastic part.

As already explained above, the electric motor drive according to the invention is a four-pole drive. According to the embodiment shown in FIGS. 2 and 3, this four-pole drive has only two carbon brushes 13, each of which is retained in a brush support arm. As is particularly clear from FIG. 2, these two brush support arms are arranged on the frame 9 and offset from each other by an angle of 90°. The ends of the carbon brushes 13 which are opposite the brush receivers 11 are also offset at an angle of 90° to each other with respect to the outer periphery of the commutator which is located in the circular inner opening of the frame 9. The existence of four carbon brushes, which is necessary in four-pole applications, is simulated by interconnecting the commutator segments, which are offset from each other by an angle of 180°, by using electrical conductors.

This is illustrated in FIG. 4, which shows a schematic view of the end face of the commutator 7. As this view shows, the commutator has four segments 6a, 6b, 6c and 6d distributed equidistantly around the outer periphery. Segment 6a is connected via an electrical conductor 14a to segment 6c, which is offset from it by an angle of 180°. Segment 6b is likewise connected via a further electrical conductor 14b to segment 6d, which is offset from it by an angle of 180°. The interconnected segments 6a, 6c are electrically isolated from the likewise interconnected segments 6b, 6d. Due to this architecture, current is simultaneously applied to segments 6a and 6c. Current is also simultaneously applied to segments 6b and 6d. The existence of four carbon brushes is simulated in this way, although only two carbon brushes are present, as is obvious from FIGS. 2 and 3.

As FIG. 2 particularly shows, there remain many free areas on the frame 9, which can be used for providing openings. In operation, cooling air can be passed through these openings to counteract overheating of the electrical components of the brush system.

According to a further embodiment, not illustrated in the figures, a total of four brush support arms in each of whose brush receivers one carbon brush is inserted, are provided on the frame. However, this additional embodiment is not preferred since, compared to the embodiment shown by FIGS. 2-4, it has a higher component outlay.

1. A four-pole electric motor drive, with a stator (1) and a rotor (2), which has a rotor shaft (3), a laminated rotor core (5) containing rotor teeth (4), and a commutator (7) fitted with segments (6), the motor drive comprising:
a hammer brush holder system (8), which has a frame (9), brush support arms (10), one end of each arm having a brush receiver (11) and the other end of each arm being connected to the frame via a rotatable bearing arrangement (12), and has carbon brushes (13), each of which is inserted in one of the brush receivers.

2. The electric motor drive as claimed in claim 1, wherein the hammer brush holder system (8) has two brush support arms, in each of whose brush receivers one carbon brush is inserted, and commutator segments which are offset from each other by an angle of 180° and are interconnected via an electrical conductor (14a, 14b).

3. The electric motor drive as claimed in claim 2, wherein the two brush support arms are arranged on the frame and offset from each other by an angle of 90°.

4. The electric motor drive as claimed in claim 1, wherein the hammer brush holder system (8) has four brush support arms in each of whose brush receivers one carbon brush is inserted.

5. The electric motor drive as claimed in claim 1, wherein the hammer brush holder system has interference suppression components (15) and carbon brushes are connected to the interference suppression components and a connecting cable (16) of the hammer brush holder system by means of one or more solid wire links (17).

6. The electric motor drive according to claim 1, wherein each of the rotatable bearing arrangements has a leg spring (18).
